(19) United States
(12) Patent Application Publication
(10) Pub. No.: US 2010/0107508 A1
(43) Pub. Date: May 6, 2010

(54) ACID-RESISTANT FILAMENTS FOR INDUSTRIAL APPLICATION AND BRUSH WITH SAME

(75) Inventors: Xianqiao Liu, Shanghai (CN); Nanjian Sun, Shanghai (CN); Ting Yu, Shanghai (CN); Mingsong Wang, Jiangsu (CN)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY DUPONT XINGDA FILAMENTS COMPANY LIMITED, Wilmington, DE (US)

(21) Appl. No.: 12/561,589

(22) Filed: Sep. 17, 2009

(30) Foreign Application Priority Data
Sep. 18, 2008 (CN) 200810213179.3

(51) Int. Cl. C09K 3/14; C08L 67/00; C08L 77/00; C08L 67/02; C08K 3/10; C08K 3/26; C08K 5/09; C08K 3/16; C08K 5/13; C08K 5/53

(52) U.S. Cl. 51/298; 524/599; 524/606; 524/605; 524/437; 524/424; 524/400; 524/394; 524/413; 524/401; 524/323; 524/130

(57) ABSTRACT

The present invention relates to a brush filament for industrial applications and a brush made with the same. The brush filament comprises a matrix resin, a hydrolytic stabilizer and/or an acid-absorbing agent, and an antioxidant. The brush filament of the invention is suitable for industrial applications, in particular, for grinding, polishing and cleaning of marbles and/or metals after they have been cut.

### CROSS-REFERENCE TO RELATED APPLICATION

This application claims priority under 35 U.S.C. 119 to Chinese Patent Application No. 200810213179.3 filed on Sep. 18, 2008, and currently pending.

### FIELD OF THE INVENTION

The present invention relates to a brush filament and its manufacturing process, and specifically to a brush filament useful in a strong acidic environment and its manufacturing process.

### BACKGROUND OF THE INVENTION

Usually, various abrasive brush filaments that have grinding and polishing functions for industrial applications are made of synthetic materials such as nylon, polyester and polyolefin with abrasive materials such as carborundum, alumina and synthetic diamond according to a certain proportion. Industrial brushes made from these abrasive brush filaments are often used for grinding, polishing, chamfering and cleaning of marbles and metals after they have been cut. For example, nylon 612 and nylon 610 are often used for making industrial brush filaments. In addition, certain polyesters such as PBT, PET, PTT and polyolefin such as PP are also synthetic polymer materials used for making industrial brush filaments. However, these brush filaments usually can only be used in an environment of pH 4-10 at ambient temperatures. When used for some specific applications, for example, for trimming and cleaning of steel plates after their acid treatment with 12% nitric acid and 3% hydrofluoric acid (pH less than 2) in a steel plant, performance and service life of these conventional brush filaments would be greatly reduced. The service life of these conventional brush filaments in a strong acidic environment is typically 6-7 days only.

Polycarbodiimide and carbodiimide have good heat resistance and high activity, and can react with many substances; therefore they have a broad range of applications. Polycarbodiimide that has been developed so far mainly has applications in the following aspects:

(1) as a reinforcing agent: Use of 1% of poly(4,4′-diphenylmethane carbodiimide) in nylon can increase melt strength and relative viscosity. Its mechanism lies in formation of a branched chain structure. Moreover, when polycarbodiimide is used to modify polyformaldehyde, its products would have better physical properties. Epoxy resins modified with polycarbodiimide, when used as an adhesive, have excellent thixotropy and stringiness.

(2) as a coating material: Polycarbodiimide has been used as a matrix resin or an additive in paint and as a matrix resin in adhesives. It is also a new cross-linking agent for paint industry. It can be self-emulsified in water and used in water-dispersible paint to provide a coating with excellent soil resistance, solvent resistance, salt spray resistance and high hardness.

(3) to make foam materials and elastomers: As carbon dioxide is generated when diisocyanate is converted into polycarbodiimide in polycondensation reaction, polycarbodiimide can be used to make molded rigid porous foam materials.

Furthermore, polycarbodiimide can also be used as an elastic component in a lot of polymer materials.

(4) as a hydrolytic stabilizer: In plastic industry, it was found a long time ago that polycarbodiimide could be used to protect polyester, polyether or polyamide from being hydrolyzed. It was found later that polycarbodiimide could also be used as a hydrolytic stabilizer for rubber.

CN 200610015736.1 disclosed a colored flat filament with high hydrolysis resistance and its manufacturing process, in which polycarbodiimide is melted with polyester to form a monofilament that has high hydrolysis resistance, fatigue resistance, wear resistance, and excellent weaving performance. However, CN 200610015736.1 does not disclose how to solve the problem with regard to acid resistance (particularly, resistance to strong acids). Meanwhile, the colored flat filament doesn't contain abrasive materials and can not be used as an abrasive brush filament that has grinding and polishing functions. Simply using hydrolytic stabilizer or antacid alone would have limited effect on increase of acid-resistance of the brush filament. Thus, there is an urgent need at present for a brush filament that has higher stability and longer service life under strong acidic conditions.

### SUMMARY OF THE INVENTION

The objective of the present invention is to provide a brush filament with higher stability and longer service life under strong acidic conditions for industrial applications.

One aspect of the present invention provides a brush filament for industrial applications, which comprises a matrix resin, a hydrolytic stabilizer and/or an acid-absorbing agent, and an antioxidant.

In a preferred embodiment according to the present invention, the matrix resin is selected from the group consisting of polyamide and/or polyester.

In a preferred embodiment according to the present invention, the polyamide is selected from the group consisting of nylon 6, nylon 66, nylon 1010, nylon 12, nylon 610, nylon 810, nylon 1212, nylon 612, high temperature nylon or a combination thereof; the polyester is selected from the group consisting of polybutylene terephthalate, polyethylene terephthalate, polypropylene terephthalate, or a combination thereof; and/or the hydrolytic stabilizer is selected from the group consisting of polycarbodiimide, carbodiimide, isocyanate, oxazoline and epoxy compounds; and/or the acid-absorbing agent is selected from aluminate hydrate acid-absorbing agent such as hydrotalcite, polyacrylamide acid-absorbing agent, calcium hydroxide, calcium stearate and/or sodium stearate.

In a preferred embodiment according to the present invention, the matrix resin accounts for 50-90% by weight, preferably 55-75% by weight, more preferably 60-70% by weight, and most preferably 65-69% by weight, based on the total weight of the brush filament; and/or the hydrolytic stabilizer accounts for 0.05-20% by weight, preferably 0.1-15% by weight, more preferably 0.1-10% by weight, and most preferably 0.1-8% by weight, based on the total weight of the brush filament; and/or the acid-absorbing agent accounts for 0.05-20% by weight, preferably 0.1-15% by weight, more preferably 0.1-10% by weight, and most preferably 0.2-5% by weight, based on the total weight of the brush filament.

In a preferred embodiment according to the present invention, the antioxidant is selected from the group consisting of a mixture of copper halide with alkali metal halide, hindered phenol, phosphonate, sulfur-containing compounds, metal acetate or a combination thereof.

In a preferred embodiment according to the present invention, the antioxidant accounts for 0.01-5% by weight, preferably 0.05-3% by weight, more preferably 0.05-1% by weight, and most preferably 0.05-0.5% by weight, based on the total weight of the brush filament.

In a preferred embodiment according to the present invention, the brush filament further comprises an abrasive material selected from the group consisting of carborundum, alumina and/or synthetic diamond.

In a preferred embodiment according to the present invention, the abrasive material accounts for 0-50% by weight, preferably 10-45% by weight, more preferably 20-40% by weight, and most preferably 25-35% by weight, based on the total weight of the brush filament.

The present invention also provides a brush comprising the brush filament of the present invention.

Based on a lot of experimental results, it has been discovered that the matrix resin is degraded in an acidic environment mainly through hydrolysis and oxidation. In consideration of the fact, the present invention greatly increases acid resistance and service life of the abrasive filament in a strong acidic environment by adding to the abrasive filament a hydrolytic stabilizer to prevent from hydrolysis and/or an acid-absorbing agent and an antioxidant to prevent from oxidation, and may optionally comprise an abrasive material.

### DETAILED DESCRIPTION OF THE INVENTION

In the present invention, the sum of all components equals 100% by weight with regard to formulation of the brush filament.

The present invention provides a brush filament for industrial applications, which comprises a matrix resin, a hydrolytic stabilizer and/or an acid-absorbing agent, and an antioxidant and optionally an abrasive material.

In the present invention, there are no specific restrictions as to the matrix resin. It may be any material used for making abrasive brush filaments in the art. In a preferred embodiment according to the present invention, the matrix resin includes nylon, polyester or a blend thereof. In another preferred embodiment according to the present invention, the nylon includes nylon 6, nylon 66, nylon 1010, nylon 12, nylon 610, nylon 810, nylon 1212, nylon 612, high temperature nylon [HTN] or a combination thereof. In another preferred embodiment according to the present invention, the polyester includes polybutylene terephthalate (PBT), polyethylene terephthalate (PET), polytrimethylene terephthalate (PTT), or a combination thereof.

In the present invention, there are no specific restrictions as to the amount of the matrix resin. It may be an amount conventionally used in the art. In a preferred embodiment according to the present invention, the matrix resin accounts for 50-90% by weight, preferably 55-75% by weight, more preferably 60-70% by weight, and most preferably 65-69% by weight, based on the total weight of the brush filament;

In the present invention, the hydrolytic stabilizer refers to a compound that can react easily with reactive hydrogen atoms contained in a polymer chain. It usually includes carbodiimide, isocyanate, oxazoline, epoxy compounds and the like, among which carbodiimide has the most desirable effect for inhibiting hydrolysis. Carbodiimide can be categorized into monocarbodiimide and polycarbodiimide (i.e., an oligomer of carbodiimide). Due to the fact that polycarbodiimide has several functional groups, it not only has end-capping effect, but also has chain extension effect to some extent, thus having a better performance to inhibit hydrolysis.

In the present invention, the acid-absorbing agent refers to stearate salt or aluminate hydrate that can react directly with acid. Its mechanism is to react directly with a small amount of acid permeated from external environment or to convert a strong inorganic acid into a weak aliphatic organic acid, thus preventing destruction and degradation of polymer backbone caused by the external strong acid. The acid-absorbing agent mainly includes aluminate hydrate acid-absorbing agent such as hydrotalcite (DHT4A), polyacrylamide acid-absorbing agent, or calcium hydroxide.

In the present invention, there are no specific restrictions as to the acid-resistant hydrolytic stabilizer or acid-absorbing agent. It may be hydrolysis-resistant polycarbodiimide and carbodiimide, or acid-absorbing calcium stearate, sodium stearate or hydrotalcite used in the art. In a preferred embodiment according to the present invention, the hydrolytic stabilizer includes polycarbodiimide and carbodiimide.

In the present invention, there are no specific restrictions as to the amount of the hydrolytic stabilizer. It may be an amount conventionally used in the art. In a preferred embodiment according to the present invention, the hydrolytic stabilizer accounts for 0.05-20% by weight, preferably 0.1-15% by weight, more preferably 0.1-10% by weight, and most preferably 0.1-8% by weight, based on the total weight of the brush filament.

In the present invention, there are no specific restrictions as to the amount of the acid-absorbing agent. It may be an amount conventionally used in the art. In a preferred embodiment according to the present invention, the acid-absorbing agent accounts for 0.05-20% by weight, preferably 0.1-15% by weight, more preferably 0.1-10% by weight, and most preferably 0.2-5% by weight, based on the total weight of the brush filament.

In the present invention, the function of the antioxidant is to prevent degradation of the brush filament due to its oxidation. It may be any antioxidant commonly used in the art. Usually, the antioxidant includes a mixture of copper halide with alkali metal halide, hindered phenol, phosphonate, sulfur-containing compounds, phosphorous acid or a combination thereof. In a preferred embodiment according to the present invention, the antioxidant is hindered phenol Irganox®, available from Ciba.

In the present invention, there are no specific restrictions as to the amount of the antioxidant. It may be an amount conventionally used in the art. In a preferred embodiment according to the present invention, the antioxidant accounts for 0.01-5% by weight, preferably 0.05-3% by weight, more preferably 0.05-1% by weight, and most preferably 0.05-0.5% by weight, based on the total weight of the brush filament.

In the present invention, the brush filament may use various additives according to a specific application. The additive may be any additive commonly used in the art, such as a flame retardant.

In the present invention, the flame retardant is a conventional one used in the art. Those of ordinary skill in the art may determine directly which flame retardants can be used for the present invention according to the description of the present invention in combination with their professional knowledge. In a preferred embodiment according to the present invention, the flame retardant is selected from the group consisting of compounds of phosphorus, bromine, chlorine, antimony and aluminum, as well as phosphate ester, halogenated hydrocarbon and antimony oxide.

In the present invention, there are no specific restrictions as to the amount of the additive. It may be an amount conventionally used in the art. In a preferred embodiment according to the present invention, the total amount or individual amount of the additives accounts for 0.1-5% by weight, preferably 0.1-3% by weight, more preferably 0.1-2% by weight, and most preferably 0.1-1% by weight, based on the total weight of the brush filament.

In the present invention, the brush filament may also comprise an abrasive material in order to enhance its grinding/polishing effects. There are no specific restrictions as to the abrasive material. It may be any abrasive material used for making abrasive brush filament in the art. In a preferred embodiment according to the present invention, the abrasive material includes carborundum, alumina, or synthetic diamond.

In the present invention, there are no specific restrictions as to the amount of the abrasive material. It may be an amount conventionally used in the art. In a preferred embodiment according to the present invention, the abrasive material accounts for 0-50% by weight, preferably 10-45% by weight, more preferably 20-40% by weight, and most preferably 25-35% by weight, based on the total weight of the brush filament.

In the present invention, the process for forming the abrasive brush filament is conventional. Those of ordinary skill in the art may determine directly which process of filament formation can be used for the present invention. In a preferred embodiment according to the present invention, the process of filament formation includes solution spinning, melt spinning, dry spinning, wet spinning, and the like.

In the present invention, there are no specific restrictions as to the shape of cross section of individual filament, as long as the filament can be used for grinding of marbles and grinding, polishing, chamfering and cleaning of metals. Usually, the shape of cross section of individual filament is round, oval, square, rectangular, triangular, rhombic, or annular.

The present invention also provides a brush comprising the brush filament of the present invention.

The brush of the present invention may be used for industrial applications, for example, for grinding, polishing and cleaning of marbles and/or metals after they have been cut.

The abrasive brush filament with good acid-resistance and its manufacturing process are further illustrated by the following examples, in which all the units are percentage by weight. These examples are provided for illustration purposes only and in no way limit the scope of the present invention.

### EXAMPLES

### Test Method for Relative Viscosity

A small amount of sample was taken from packed abrasive filament, and treated with pre-formulated 0.1M sulfuric acid. The sample was taken out after 40 days of treatment. Relative viscosity of the abrasive filament prior to and after the treatment was measured by using Ubbelohde viscometer commonly used in polymer science after dissolving the sample with 90% formic acid or 98% sulfuric acid.

### Example 1

1. 4.93 kg of nylon 610 resin, 0.05 kg of polycarbodiimide (Staboxol® P100, available from Rhein Chemie) and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 3.27 and 3.26 respectively with a 3% reduction in the relative viscosity.

### Example 2

1. 4.955 kg of nylon 610 resin, 0.025 kg of sodium stearate and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.34 and 2.34 respectively with a 0% reduction in the relative viscosity.

### Comparative Example 1 (Blank Sample)

1. 5.00 kg of nylon 610 resin was taken without any additives, such as a hydrolytic stabilizer and/or an acid-absorbing agent, being added.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.90 and 2.59 respectively with a 10.7% reduction in the relative viscosity.

### Comparative Example 2

1. 4.98 kg of nylon 610 resin and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.88 and 2.80 respectively with a 2.7% reduction in the relative viscosity.

### Comparative Example 3

1. 4.98 kg of nylon 610 resin and 0.025 kg of sodium stearate were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.49 and 2.40 respectively with a 3.6% reduction in the relative viscosity.

### Comparative Example 4

1. 4.98 kg of nylon 610 resin and 0.05 kg of polycarbodiimide were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 3.27 and 3.20 respectively with a 2.1% reduction in the relative viscosity.

### Example 3

1. 4.91 kg of PBT resin, 0.05 kg of carbodiimide, 0.02 kg of hydrotalcite and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.92 and 2.90 respectively with a 0.7% reduction in the relative viscosity.

### Example 4

1. 4.92 kg of PBT resin, 0.04 kg of carbodiimide, 0.02 kg of hydrotalcite and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 1.45 and 1.43 respectively with a 1.4% reduction in the relative viscosity.

### Example 5

1. 4.45 kg of PBT resin, 0.5 kg of carbodiimide, 0.02 kg of hydrotalcite and 0.03 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 1.51 and 1.49 respectively with a 1.3% reduction in the relative viscosity.

### Example 6

1. 4.9 kg of nylon 1010 resin, 0.05 kg of carbodiimide, 0.02 kg of hydrotalcite and 0.03 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 2.85 and 2.81 respectively with a 1.4% reduction in the relative viscosity.

### Example 7

1. 4.96 kg of PBT resin, 0.01 kg of carbodiimide and 0.03 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 1.46 and 1.45 respectively with a 0.7% reduction in the relative viscosity.

### Example 8

1. 4.78 kg of PBT resin, 0.02 kg of hydrotalcite and 0.02 kg of hindered phenol antioxidant Irganox® 1098 were uniformly mixed.

2. The above-described mixture was passed through a twin screw extruder while 2.14 kg of abrasive carborundum was added through a side feeder in order to carry out conventional melt spinning.

3. The filament spun from a spinning die was cooled by water in a water bath, stretched by a roller, and solidified with hot air, and then packed as abrasive filament for industrial applications.

4. A small amount of sample was taken from the packed abrasive filament, and treated with pre-formulated 0.1M sulfuric acid. The sample was taken out after 40 days of treatment. Relative viscosity of the abrasive filament prior to and after the treatment was measured as 1.44 and 1.42 respectively with a 1.38% reduction in the relative viscosity.

What is claimed is:

1. A brush filament for industrial applications, comprising a matrix resin, an antioxidant, and a hydrolytic stabilizer and/or an acid-absorbing agent.

2. The brush filament according to claim 1, wherein the matrix resin is selected from the group consisting of polyamide and polyester.

3. The brush filament according to claim 2, wherein the polyamide is selected from the group consisting of nylon 6, nylon 66, nylon 1010, nylon 12, nylon 610, nylon 810, nylon 1212, nylon 612, high temperature nylon, or a combination thereof; the polyester is selected from the group consisting of polybutylene terephthalate, polyethylene terephthalate, polypropylene terephthalate, or a combination thereof; and/or the hydrolytic stabilizer is selected from the group consisting of polycarbodiimide, carbodiimide, isocyanate, oxazoline and epoxy compounds; and/or the acid-absorbing agent is selected from an aluminate hydrate acid-absorbing agent selected from hydrotalcite, polyacrylamide acid-absorbing agent, calcium hydroxide, calcium stearate and sodium stearate.

4. The brush filament according to claim 1, wherein the matrix resin accounts for 50-90% by weight, preferably 55-75% by weight, more preferably 60-70% by weight, and most preferably 65-69% by weight, based on the total weight of the brush filament; and/or the hydrolytic stabilizer accounts for 0.05-20% by weight, preferably 0.1-15% by weight, more preferably 0.1-10% by weight, and most preferably 0.1-8% by weight, based on the total weight of the brush filament; and/or the acid-absorbing agent accounts for 0.05-20% by weight, preferably 0.1-15% by weight, more preferably 0.1-10% by weight, and most preferably 0.2-5% by weight, based on the total weight of the brush filament.

5. The brush filament according to claim 1, wherein the antioxidant is selected from the group consisting of a mixture of copper halide with alkali metal halide, hindered phenol, phosphonate, sulfur-containing compounds, metal acetate or a combination thereof.

6. The brush filament according to claim 1, wherein the antioxidant accounts for 0.01-5% by weight, preferably 0.05-3% by weight, more preferably 0.05-1% by weight, and most preferably 0.05-0.5% by weight, based on the total weight of the brush filament.

7. The brush filament according to claim 1, wherein the brush filament further comprises an abrasive material.

8. The brush filament according to claim 7, wherein the abrasive material is selected from the group consisting of carborundum, alumina and synthetic diamond.

9. The brush filament according to claim 7, wherein the abrasive material accounts for 0-50% by weight, preferably 10-45% by weight, more preferably 20-40% by weight, and most preferably 25-35% by weight, based on the total weight of the brush filament.

10. A brush comprising the brush filament according to claim 1.
